(19) United States
(12) Patent Application Publication
(10) Pub. No.: US 2007/0057646 A1
(43) Pub. Date: Mar. 15, 2007

(54) Automatic anti-trap device

(75) Inventors: Yu-Chia Hsu, Kuei San (TW); Te-Yang Shen, Kuei San (TW); Ming Yeh, Kuei San (TW); Yuan-Ying Yu, Kuei San (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/298,577

(22) Filed: Dec. 12, 2005

(30) Foreign Application Priority Data
Sep. 14, 2005 (TW) 94131661

(51) Int. Cl. H02P 3/00

(52) U.S. Cl. 318/466

(57) ABSTRACT

An automatic anti-trap device is provided to add safety to other apparatuses. The automatic anti-trap device of this invention has a driving circuit to control a motor, a current sensor to generate a current signal, a current ripple peak value circuit to generate a current ripple peak value signal according to the current signal, and a micro processor to generate a working signal for the driving circuit to control the motor according to a keystroke signal, the current signal and the current ripple peak value signal.

### Related Applications

The present application is based on, and claims priority from, Taiwan Application Serial Number 94131661, filed Sep. 14, 2005, the disclosure of which is hereby incorporated by reference herein in its entirety.

### BACKGROUND

1. Field of Invention

The present invention relates to an automatic anti-trap device, and especially relates to an automatic anti-trap device used on the power window of an automobile.

2. Description of Related Art

Transmissions comprised of a motor, gear module or screw are often used in daily life. These transmissions can facilitate such items as the power windows of an automobile, power gates, roller gates and conveyers. This kind of transmission has high output force and low power consumption to move a heavy object. But when the transmission works abnormally, such as when trapping an object or becoming blocked, the transmission is easily damaged and the trapped object is easily injured. Unless a person stops the transmission motion, the typical transmission, which does not have an automatic anti-trap device, can injure a person or damage an object by its high output force.

FIG. 1 is a functional block diagram of the automatic anti-trap device according to a prior art. This automatic anti-trap device comprises a micro processor 150, a driving circuit 130 and a position sensor 120. The driving circuit 130 and the position sensor 120 couple to the micro processor 150, and the driving circuit 130 and the position sensor 120 couple to the motor 110 separately. Furthermore, the micro processor 150 couples to a memory 170 to store the processed data. The motor 110 moves a window 199 (such as power window of an automobile) by coupling to a gear module 190. The micro processor 150 uses the position signals detected by the position sensor 120 to get time intervals and torques of the motor and compares the intervals and torques with the interval threshold value and torque threshold value stored in micro processor 150. When the time interval or torque is greater than the threshold values, the automatic anti-trap device stops or reverses the motor 110.

However, as time goes by, the physical condition of the device changes as the motor or machine ages. Hence, this kind of automatic anti-trap device easily exhibits error in action unless its threshold values are updated accordingly.

FIG. 2 is a functional block diagram of the automatic anti-trap device according to another prior art, which is different from that shown in FIG. 1 in that the position sensor 220 and the proximity sensor 225 of FIG. 2 are set at the border of the window 199 rather than coupled to the motor 110. The micro processor 250 makes logical judgments according to the information from position sensor 220 and the proximity sensor 225. This kind of device has an advantageous simple algorithm but is disadvantaged in that establishing the sensors and circuits at the border of the window 199 is difficult to design and costly to produce.

Therefore, an automatic anti-trap device is needed with updatable threshold values and is easily maintained and inexpensive to improve the transmission safety.

### SUMMARY

It is an objective of the present invention to provide an automatic anti-trap device.

It is another objective of the present invention to provide an automatic anti-trap device that is easily maintained and inexpensive.

It is another objective of the present invention to provide an automatic anti-trap device exhibiting safety, sensitivity and stability.

It is another objective of the present invention to provide a method of operating an automatic anti-trap device.

In accordance with the foregoing objectives, an embodiment of this invention provides an automatic anti-trap device. The automatic anti-trap device is provided to add safety to other apparatuses. The automatic anti-trap device of this invention comprises a driving circuit to control a motor, a current sensor to generate a current signal, a current ripple peak value circuit to generate a current ripple peak value signal according to the current signal, and a micro processor to generate a working signal for the driving circuit to control the motor according to a keystroke signal, the current signal and the current ripple peak value signal.

An embodiment of this invention further comprises a current ripple peak value circuit. The current ripple peak value circuit is used to generate a current ripple peak value signal according to the current signal. The micro processor can compute a position of the window according to the current ripple peak value signal and judge whether the window is at an anti-trap zone for generating the working signal according to the current signal.

The micro processor of this embodiment can update threshold values of this automatic anti-trap device to avoid erroneous actions caused by usage wear. Moreover, these sensors (the current sensor and the current ripple peak value circuit) do not need to be established at the border of the window; this automatic anti-trap device is thus easy to maintain and inexpensive.

### BRIEF DESCRIPTION OF THE DRAWINGS

The invention can be more fully understood by reading the following detailed description of the preferred embodiment with reference made to the accompanying drawings as follows:

FIG. 1 is a functional block diagram of the automatic anti-trap device according to a prior art;

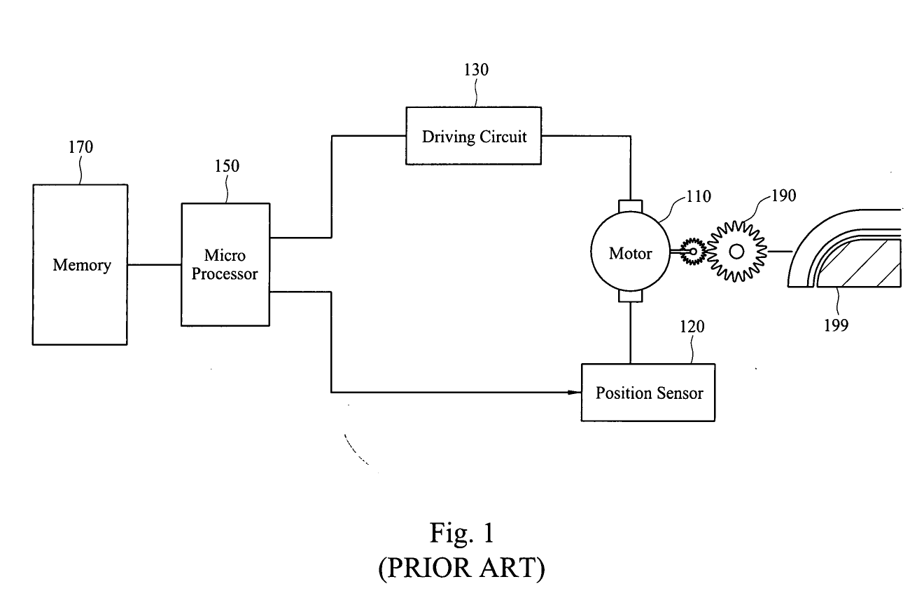

FIG. 2 is a functional block diagram of the automatic anti-trap device according to another prior art;

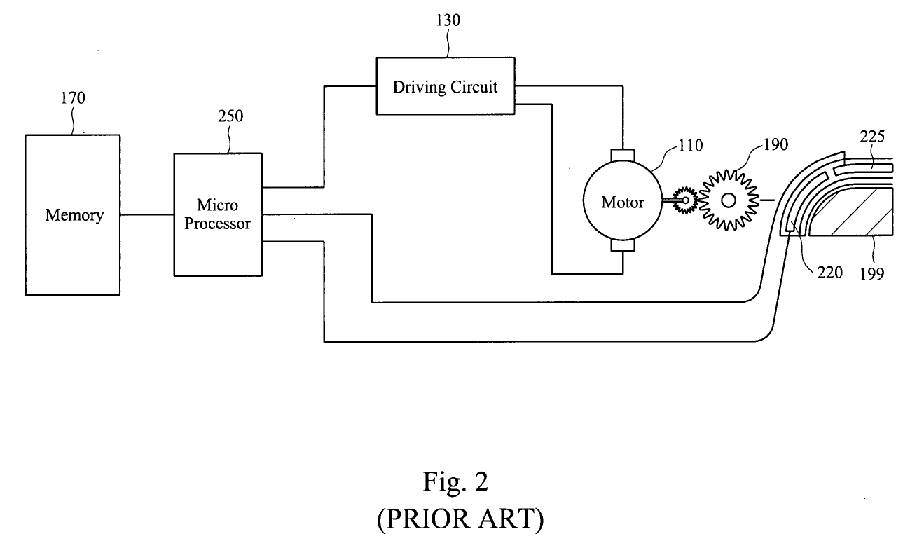

FIG. 3 is a functional block diagram of the automatic anti-trap device according to one preferred embodiment of this invention;

FIG. 4 illustrates the anti-trap zone according to one preferred embodiment of this invention; and

FIG. 5 is the flow chart of a method to operate an automatic anti-trap device according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

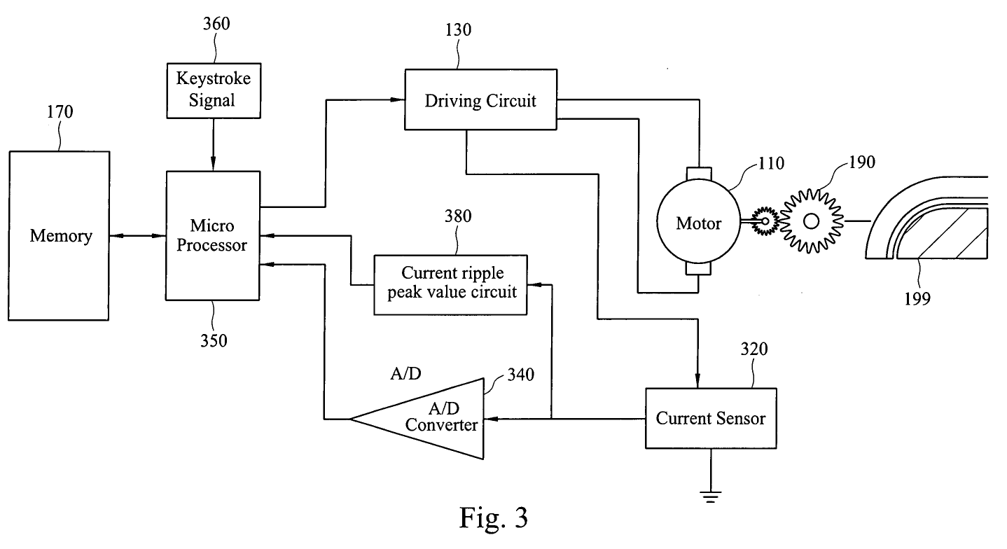

FIG. 3 is a functional block diagram of the automatic anti-trap device according to one preferred embodiment of this invention. This embodiment can detect the position of the window to judge whether the window is at an anti-trap zone.

This automatic anti-trap device comprises a micro processor 350, a driving circuit 130, a current sensor 320 and a current ripple peak value circuit 380. The driving circuit 130 and the current ripple peak value circuit 380 are coupled to the micro processor 350 separately. The driving circuit 130 is coupled to a transmission (such as motor 110) and the current sensor 320. Furthermore, the micro processor 350 couples to a memory 170 to store the processed data and handles a keystroke signal. The motor 110 moves a window 199 by coupling to a gear module 190.

The output end of the current sensor 320 connects to the input end of current ripple peak value circuit 380. The current sensor 320 generates a current signal for the micro processor 350 and the current ripple peak value circuit 380. The current signal varies with changing current of the motor 110, brush, gear module or screw. Thus, the current ripple peak value circuit 380 can generate a current ripple peak value signal by the varied current signal. Meanwhile, the micro processor 350 uses the current signals from the current sensor 320 to get a normal current signal. When an accident occurs (such as trapping an object), the current is abnormal by the abnormal torque of the motor 110. The abnormal current changes the current signal. A first threshold value and a second threshold value of the current signal are determined from the normal current signal, wherein the second threshold value is greater than the first threshold value (such as the first threshold value set to be 10% greater than the normal current signal, and the second threshold value set to be 30% greater than the normal current signal). These two threshold values are updatable to reduce the erroneous actions caused by aging machines. The micro processor 350 gets a position of the window 199 after processing the current ripple peak value signal (such as by counting the number of the current ripple peak value signals). Therefore, the micro processor 350 compares the information of the position with the preset information of an anti-trap zone and judges whether the window is at the anti-trap zone.

When the current signal is analog type, the embodiment of this invention further comprises an analog to digital converter 340 coupled between the current sensor 320 and the micro processor 350. The analog to digital converter 340 is used to transform an analog signal into a digital signal for the micro processor 350. Moreover, the micro processor 350 can compute different first threshold values and second threshold values by different positions to get more precise threshold values.

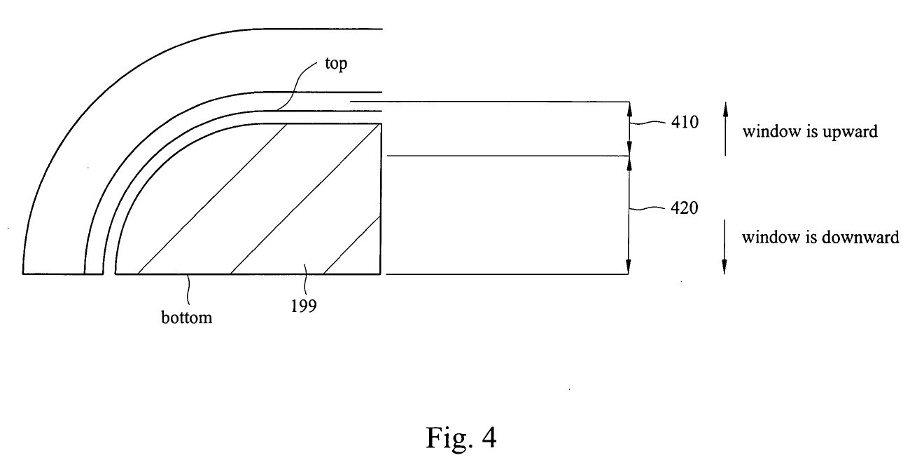

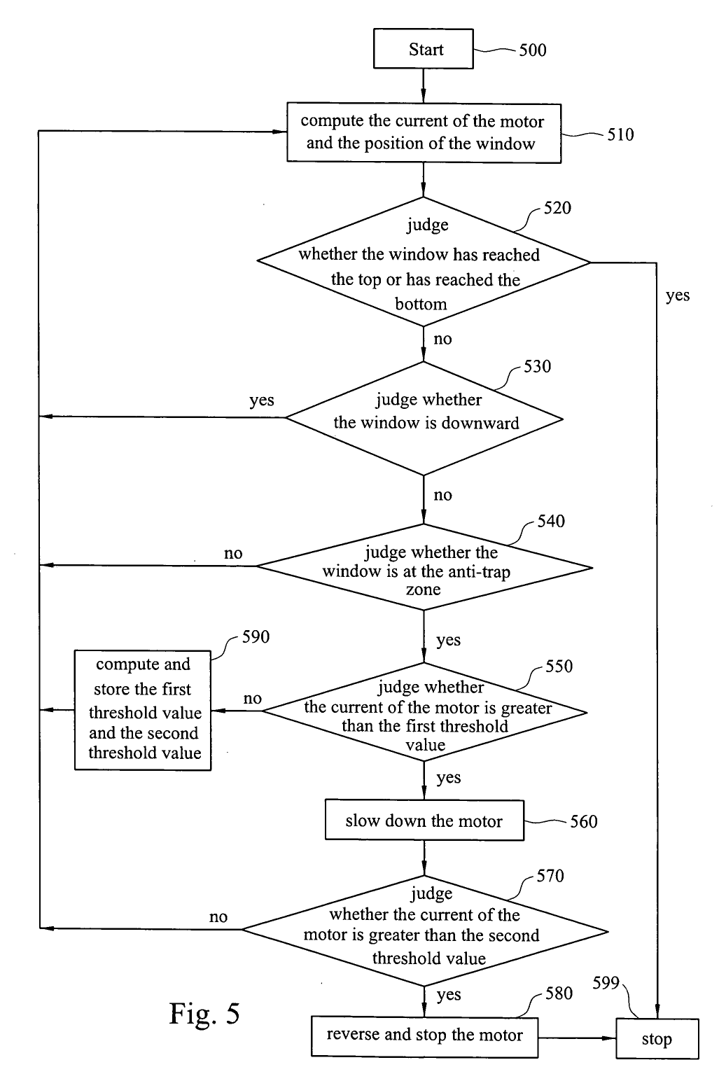

FIG. 4 illustrates the anti-trap zone according to one preferred embodiment of this invention. The window 199 can be moved between the top and the bottom, and the movable zone can be divided into an anti-trap zone 410 and a non anti-trap zone 420. Users can decide the size of the anti-trap zone 410 according to their requirements. FIG. 5 is a flow chart of a method to operate an automatic anti-trap device according to one preferred embodiment of this invention. Referring also to FIG. 3, the method of this embodiment first starts to move the window (step 500). Then, the method computes a current of the motor and the position of the window (step 510) and judges whether the current of the motor is greater than the first threshold value (step 550). When the current of the motor is greater than the first threshold value, whether the current of the motor is greater than the second threshold value is judged (step 570), wherein the second threshold value is greater than the first threshold value. When the current of the motor is greater than the second threshold value, the window is stopped from moving (step 599).

The method further comprises a step after step 510 to judge whether the upward window has reached the top or whether the downward window has reached the bottom (step 520). When the upward window is at the top or the downward window is at the bottom, the method executes step 599 to stop moving the window. When the window is not at the top and not at the bottom, the method further comprises a step to judge whether the window is downward (step 530). When the window is downward, the method continues to move the window downward and execute step 510. When the window is not downward, the method further comprises a step to judge whether the window is at an anti-trap zone (step 540). When the window is at the anti-trap zone, the method executes step 550. When the window is not at the anti-trap zone, the method executes step 510.

In step 550, when the current of the motor is greater than the first threshold value, the method further comprises a step before step 570 to slow down the motor. In step 550, when the current of the motor is not greater than the first threshold value, the method further comprises a step to re-compute and update the first threshold value and the second threshold value (step 590), and then execute step 510. In step 570, when the current of the motor is greater than the second threshold value, the method further comprises a step before step 599 for reversing and stopping the motor (step 580) to reverse the window for a preset distance or to a preset position. In step 570, when the current of the motor is not greater than the second threshold value, the method executes step 510.

Although the present invention has been described in considerable detail with reference to certain preferred embodiments thereof, other embodiments are possible. Therefore, the spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An automatic anti-trap device, comprising:
a motor;
a driving circuit coupling to the motor used to control the motor;
a current sensor coupling to the driving circuit used to detect a current signal;
a current ripple peak value circuit coupling to the current sensor used to generate a current ripple peak value signal according to the current signal; and
a micro processor used to store data, judge whether the automatic anti-trap device traps an object according to a keystroke signal, the current signal and the current ripple peak value signal, and generate a working signal for the driving circuit to control the motor.

2. The automatic anti-trap device of claim 1, further comprising a transmission coupling to the motor, wherein the transmission is used to move a window.

3. The automatic anti-trap device of claim 2, wherein the micro processor computes a position of the window according to the current ripple peak value signal.

4. The automatic anti-trap device of claim 3, wherein the micro processor judges whether the window is at an anti-trap zone and generates the working signal according to the position of the window and the current signal.

5. The automatic anti-trap device of claim 1, wherein when the current signal is analog type, further comprising an analog to digital converter, wherein the analog to digital converter is used to transform an analog signal into a digital signal for the micro processor.

6. The automatic anti-trap device of claim 1, further comprising a memory, wherein the memory is used to store the processed data of the micro processor.

7. A method of operating an automatic anti-trap device to control a window, comprising:
(a) starting to move the window;
(b) computing a current of a motor and a position of the window;
(c) judging whether the current of the motor is greater than the first threshold value;
(d) when the current of the motor is greater than the first threshold value, judging whether the current of the motor is greater than the second threshold value, wherein the second threshold value is greater than the first threshold value; and
(e) when the current of the motor is greater than the second threshold value, stopping to move the window.

8. The method of operating an automatic anti-trap device of claim 7, further comprising a step after step (b) to judge whether the window is at the top or at the bottom.

9. The method of operating an automatic anti-trap device of claim 8, wherein when the window is at the top or at the bottom, executing step (e) to stop moving the window.

10. The method of operating an automatic anti-trap device of claim 8, wherein when the window is not at the top and not at the bottom, further comprising a step to judge whether the window is downward.

11. The method of operating an automatic anti-trap device of claim 10, when the window is downward, continuing to move the window downward and execute step (b).

12. The method of operating an automatic anti-trap device of claim 10, wherein when the window is not downward, further comprising a step to judge whether the window is at an anti-trap zone.

13. The method of operating an automatic anti-trap device of claim 12, wherein when the window is at the anti-trap zone, executing step (c).

14. The method of operating an automatic anti-trap device of claim 12, wherein when the window is not at the anti-trap zone, executing step (b).

15. The method of operating an automatic anti-trap device of claim 7, wherein when the current of the motor is greater than the first threshold value in step (c), further comprising a step before step (d) to slow down the motor.

16. The method of operating an automatic anti-trap device of claim 7, when the current of the motor is not greater than the first threshold value in step (c), further comprising a step to re-compute and update the first threshold value and the second threshold value, and then execute step (b).

17. The method of operating an automatic anti-trap device of claim 7, wherein when the current of the motor is greater than the second threshold value in step (d), further comprising a step before step (e) to pause the motor and then reverse the window for a preset distance or to a preset position.

18. The method of operating an automatic anti-trap device of claim 7, wherein when the current of the motor is not greater than the second threshold value in step (d), executing step (b).

19. A method of operating an automatic anti-trap device to control a window, comprising:
(a) starting to move the window;
(b) computing a current of a motor and a position of the window;
(c) judging whether the current of the motor is greater than the first threshold value;
(d) when the current of the motor is greater than the first threshold value, judging whether the current of the motor is greater than the second threshold value, wherein the second threshold value is greater than the first threshold value; and
(e) when the current of the motor is greater than the second threshold value, stopping to move the window.

20. The method of operating an automatic anti-trap device of claim 19, further comprising a step after step (b) to judge whether the window is at the top or at the bottom.

21. The method of operating an automatic anti-trap device of claim 20, wherein when the window is at the top or at the bottom, executing step (e) to stop moving the window.

22. The method of operating an automatic anti-trap device of claim 20, wherein when the window is not at the top and not at the bottom, further comprising a step to judge whether the window is downward.

23. The method of operating an automatic anti-trap device of claim 22, wherein when the window is downward, continuing to move the window downward and execute step (b).

24. The method of operating an automatic anti-trap device of claim 22, wherein when the window is not downward, executing step (c).

25. The method of operating an automatic anti-trap device of claim 19, wherein when the current of the motor is greater than the first threshold value in step (c), further comprising a step before step (d) to slow down the motor.

26. The method of operating an automatic anti-trap device of claim 19, wherein when the current of the motor is not greater than the first threshold value in step (c), further comprising a step to re-compute and update the first threshold value and the second threshold value, and then execute step (b).

27. The method of operating an automatic anti-trap device of claim 19, wherein when the current of the motor is greater than the second threshold value in step (d), further comprising a step before step (e) to pause the motor and then reverse the window for a preset distance or to a preset position.

28. The method of operating an automatic anti-trap device of claim 19, wherein when the current of the motor is not greater than the second threshold value in step (d), executing step (b).

29. An automatic anti-trap device, comprising:
a motor;
a driving circuit coupling to the motor used to control the motor;
a current sensor coupling to the driving circuit used to detect a current signal; and
a micro processor used to store data, judge whether the automatic anti-trap device traps an object according to a keystroke signal, the current signal and the current ripple peak value signal, and generate a working signal for the driving circuit to control the motor.

30. The automatic anti-trap device of claim 29, further comprising a transmission coupling to the motor, wherein the transmission is used to move a window.

31. The automatic anti-trap device of claim 29, further comprising a current ripple peak value circuit coupling to the current sensor, wherein the current ripple peak value circuit is used to generate a current ripple peak value signal according to the current signal.

32. The automatic anti-trap device of claim 31, wherein the micro processor coupling to the current ripple peak value circuit computes a position of the window according to the current ripple peak value signal.

33. The automatic anti-trap device of claim 32, wherein the micro processor judges whether the window is at an anti-trap zone and generates the working signal according to the position of the window and the current signal.

34. The automatic anti-trap device of claim 29, wherein when the current signal is analog type, further comprising an analog to digital converter, wherein the analog to digital converter is used to transform an analog signal into a digital signal for the micro processor.

35. The automatic anti-trap device of claim 29, further comprising a memory, wherein the memory is used to store the processed data of the micro processor.
